(19) United States
(12) Patent Application Publication
(10) Pub. No.: US 2026/0188764 A1
(43) Pub. Date: Jul. 2, 2026

(54) POWER SUPPLY SYSTEM FOR A POWER TOOL

(71) Applicant: Milwaukee Electric Tool Corporation, Brookfield, WI (US)

(72) Inventors: Richard A. Behnke, Milwaukee, WI (US); Maxwell A. Casper, Menomonee Falls, WI (US); Tyler Graham, Brookfield, WI (US)

(21) Appl. No.: 19/418,453

(22) Filed: Dec. 12, 2025

Related U.S. Application Data
(60) Provisional application No. 63/741,250, filed on Jan. 2, 2025.

(51) Int. Cl. H01M 10/42; H01M 50/247; H01M 50/256

(52) U.S. Cl. CPC H01M 10/425; H01M 50/247; H01M 50/256; H01M 2220/30

(57) ABSTRACT

Power supply systems for a power tool and power tool systems are provided. A power supply system for a power tool includes a first battery control circuit operable to interface one or more first batteries, the first battery control circuit having a first positive terminal and a first negative terminal. The power supply system further includes a second battery control circuit operable to interface one or more second batteries, the second battery control circuit having a second positive terminal and a second negative terminal. The power supply system further includes a first diode electrically coupled between the first positive terminal and the second negative terminal. The power supply system further includes a second diode electrically coupled between the first negative terminal and the second positive terminal.

### CROSS-REFERENCE TO RELATED APPLICATIONS

This application is a non-provisional application claiming the benefit of priority under 35 U.S.C. § 119(e) to U.S. Provisional Application No. 63/741,250, filed Jan. 2, 2025, which is hereby incorporated by reference in its entirety.

### FIELD

The present disclosure relates generally to a power supply system for a power tool, and more specifically to negative voltage suppression for a power tool power supply system.

### BACKGROUND

Power tools are generally utilized in lieu of hand tools. Power tools can perform the same, or similar, tasks as hand tools at higher efficiency, allowing the operator controlling the power tool to use less effort in achieving a task. For example, powered hedge trimmers can trim foliage faster than traditional yard shears.

Power tools may have gas motors or electric motors onboard the power tool. For electric motors, power may be supplied by plugging the power tool into an electrical outlet, charging a battery built into the power tool, or selectively providing one or more removable batteries for the power tool. In some instances, the same removable battery may be compatible with multiple different power tools. Thus, an operator may selectively provide a rechargeable battery to a first power tool, then, upon completion of an operation, remove the rechargeable battery from the first power tool and provide it to a second power tool. However, power supply systems with batteries onboard the power tools can add weight to the power tool and impede its overall movement.

Accordingly, improved power supply systems for power tools are desired in the art. In particular, a power tool power supply system which provides negative voltage suppression would be advantageous.

### BRIEF DESCRIPTION

Aspects and advantages of the present disclosure will be set forth in part in the following description, or may be obvious from the description, or may be learned through practice of the technology.

In accordance with one embodiment, a power supply system for a power tool is provided. The power supply system includes a first battery control circuit operable to interface one or more first batteries, the first battery control circuit having a first positive terminal and a first negative terminal. The power supply system further includes a second battery control circuit operable to interface one or more second batteries, the second battery control circuit having a second positive terminal and a second negative terminal. The power supply system further includes a first diode electrically coupled between the first positive terminal and the second negative terminal. The power supply system further includes a second diode electrically coupled between the first negative terminal and the second positive terminal. The power supply system is operable to provide power to the power tool via a tether cable, the tether cable configured to couple the first battery control circuit and the second battery control circuit of the power supply system to one or more tool battery interfaces of the power tool.

In accordance with another embodiment, a power tool system is provided. The power tool system includes a power tool comprising one or more tool battery interfaces for receiving power. The power tool system further includes a tether cable comprising one or more adapter assemblies operable to connect the tether cable to the one or more tool battery interfaces of the power tool. The power tool system further includes a power supply system operable to provide power to the power tool via the tether cable. The power supply system includes a first battery control circuit operable to interface one or more first batteries, the first battery control circuit having a first positive terminal and a first negative terminal. The power supply system further includes a second battery control circuit operable to interface one or more second batteries, the second battery control circuit having a second positive terminal and a second negative terminal. The power supply system further includes a first diode electrically coupled between the first positive terminal and the second negative terminal. The power supply system further includes a second diode electrically coupled between the first negative terminal and the second positive terminal.

In accordance with another embodiment, a power tool system is provided. The power tool system includes a dual battery power tool comprising a first tool battery interface and a second tool battery interface for receiving power. The power tool system further includes a backpack power supply system operable to provide power to the dual battery power tool. The backpack power supply system includes a first battery control circuit operable to interface one or more first batteries, the first battery control circuit having a first positive terminal and a first negative terminal. The backpack power supply system further includes a second battery control circuit operable to interface one or more second batteries, the second battery control circuit having a second positive terminal and a second negative terminal. The backpack power supply system further includes a first diode electrically coupled between the first positive terminal and the second negative terminal. The backpack power supply system further includes a second diode electrically coupled between the first negative terminal and the second positive terminal.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 depicts a power supply system and a tether cable for a power tool in accordance with embodiments of the present disclosure;

FIG. 2 depicts a power tool system in use by a user in accordance with embodiments of the present disclosure;

FIG. 3 provides a circuit schematic of an example power tool system in accordance with embodiments of the present disclosure;

FIG. 4 provides another circuit schematic of an example power tool system in accordance with embodiments of the present disclosure;

FIG. 5 provides another circuit schematic of an example power tool system in accordance with embodiments of the present disclosure;

FIG. 6 provides a circuit schematic of an example battery control circuit and example batteries in accordance with embodiments of the present disclosure; and

FIG. 7 provides a block diagram of a controller according to example embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, aspects of the present disclosure are directed to negative voltage suppression in a power supply system for a power tool. The power supply system may include a modular design having two electrically isolated battery control circuits. Each battery control circuit may be operable to interface one or more batteries that may be connected to an output connection via, for instance, a solid state disconnect switch. Specifically, each battery control circuit of the power supply system may include a positive output terminal (e.g., positive terminal) and a negative output terminal (e.g., negative terminal).

The outputs of the battery control circuits may be operably coupled to one or more adapter assemblies via a tether cable. Each adapter assembly may be operable to be connected to either the high side or the low side battery interface of a power tool (e.g., single battery power tool, dual battery power tool, etc.). For example, the flexible power supply system may be a wearable power supply system, such as a backpack power supply system.

When installing and un-installing batteries in a multi-battery series configuration, there may be a risk of creating a negative voltage on the circuit nets. For instance, a reference for the voltage may be removed and the circuit may discharge energy via a new path, creating a negative voltage in the circuit. The negative voltage may exceed component ratings and potentially cause permanent damage to the power supply system and/or power tool.

Accordingly, aspects of the present disclosure include negative voltage suppression circuitry that may provide a path to discharge energy in a controlled manner and provide for a constant ground reference in a modular design.

Specifically, a set of diodes may be connected across the battery control circuits of the power supply system such that an anode of each diode is coupled to a negative terminal and a cathode of each diode is coupled to a positive terminal.

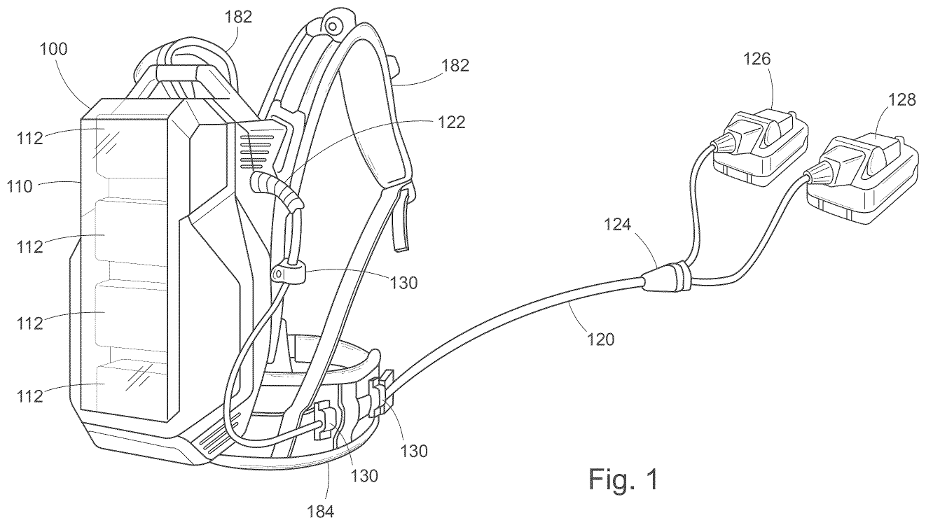

Referring now to the drawings, FIG. 1 illustrates a power supply system 100 according to example embodiments of the present disclosure. Power supply system 100 is operable to provide power to a power tool via the tether cable 120. In some embodiments, power supply system 100 may allow for relative motion between the power supply system 100 and a power tool during operation. For instance, the power supply system may be operable to provide power to a power tool via a tether cable 120.

Power supply system 100 may include a power source housing 110. Power source housing 110 may be a fully or partially enclosed space for storing one or more power sources such as batteries 112. As illustrated in FIG. 1, the power source housing 110 may be configured to house four batteries 112, although those of ordinary skill in the art will understand power source housing 110 may be configured to house any number of batteries 112 without deviating from the scope of the present disclosure. Batteries 112 may be removable batteries that are operable to be installed and un-installed into the battery ports of the power supply system 100.

In some embodiments, power supply system 100 may be a wearable power supply system, such as a backpack power supply. Accordingly, power supply system 100 may include one or more shoulder straps and/or a hip strap 184 to secure the power supply system 100 to a user during operation.

As shown in FIG. 1, power supply system 100 may be operable to provide power via tether cable 120. For instance, power supply system 100 may include a tether interface 122 electrically coupling tether cable 120 to power supply system 100. In some embodiments, power supply system 100 may include tether clips 130 configured to guide tether cable 120. As shown, one or more tether clips 130 may be mounted to hip strap 184.

Tether cable 120 may further include one or more adapter assemblies 126, 128 operable to connect power supply system 100 to one or more battery interfaces of a power tool. In some embodiments, tether cable 120 may include a Y portion 124 such that multiple adapter assemblies 126, 128 may operably connect to power supply system 100.

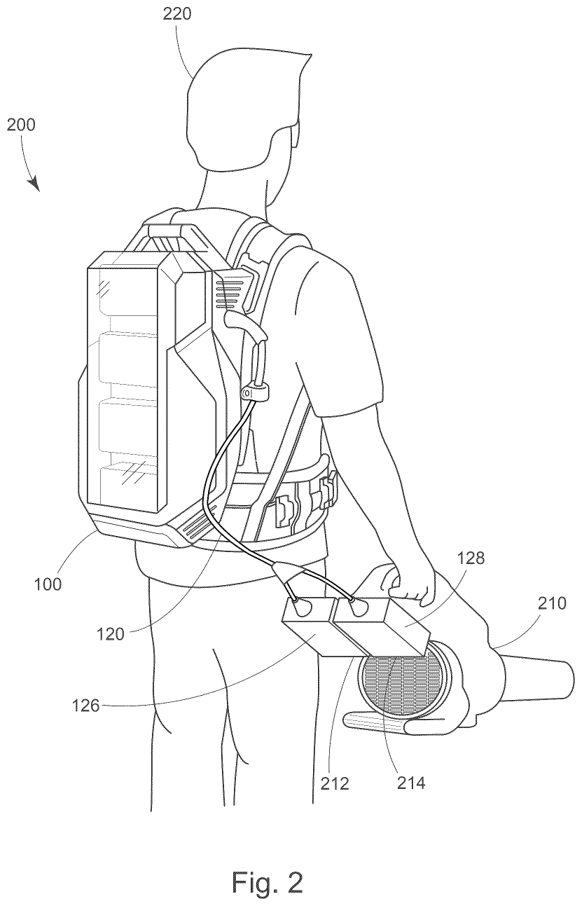

FIG. 2 illustrates a power tool system 200 according to example embodiments of the present disclosure. Specifically, power tool system 200 is illustrated in FIG. 2 while being operated by a user 220. As shown, power tool system 200 may include a power supply system 100, tether cable 120, and power tool 210.

As previously described with reference to FIG. 1, tether cable 120 may allow for relative motion between the power supply system 100 and a power tool 210 during operation. As shown in FIG. 2, power supply system 100 may be positioned on the back of user 220 while power tool 210 may be a hand-held power tool that is movable relative to power supply system 100 during operation of the power tool system 200.

While power tool 210 is depicted in FIG. 2 as a leaf blower for purposes of illustration and discussion, those of ordinary skill in the art will understand that power supply system 100 may be operable to provide power to any type of power tool without deviating from the scope of the present disclosure.

Tether cable 120 may be configured to electrically couple the power supply system 100 to the power tool 210. Specifically, tether cable 120 may include one or more adapter assemblies 126, 128 operable to connect the tether cable 120 to one or more tool battery interfaces 212, 214 of the power tool 210. In some embodiments, tool battery interfaces 212, 214 may be operable to directly connect power tool 210 with one or more removable batteries, such as batteries 112 depicted in FIG. 1. As such, adapter assemblies 126, 128 may have connection configurations similar to that of removable batteries such that an adapter assembly 126, 128 is interchangeable with a removable battery compatible with power tool 210.

In some embodiments, power tool 210 may be a dual battery power tool having a first tool battery interface 212 and a second tool battery interface 214 such that power tool 210 may receive power from two batteries. For instance, first tool battery interface 212 may be a high side battery interface and second tool battery interface 214 may be a low side battery interface. In alternative embodiments, power tool 210 may be a single battery power tool having only a single battery interface (e.g., low side battery interface).

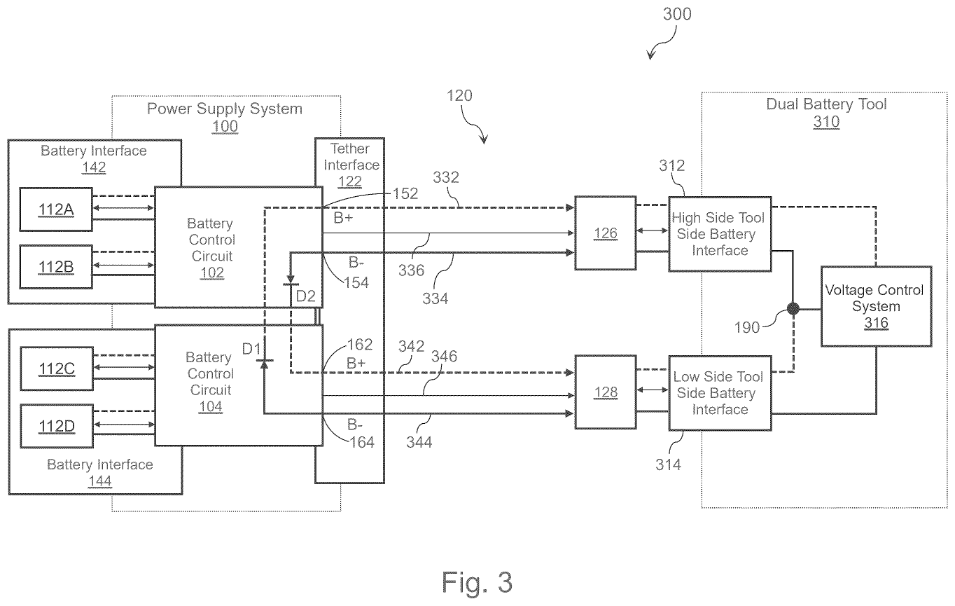

Referring now to FIG. 3, a circuit schematic of an example power tool system 300 is provided in accordance with embodiments of the present disclosure. Power tool system 300 may include a power supply system 100, a dual battery power tool 310, and a tether cable 120 operable to electrically connect power supply system 100 to a dual battery tool 310.

As shown in FIG. 3, power supply system 100 includes two battery control circuits 102, 104 that may be electrically isolated from one another. A first battery control circuit 102 may be operable to interface one or more first batteries 112A, 112B (e.g., one or more first removable batteries) via a first dual battery interface 142 of the power supply system 100. Additionally, a second battery control circuit 104 may be operable to interface one or more second batteries 112C, 112D (e.g., one or more second removable batteries) via a second dual battery interface 144 of the power supply system 100.

In some embodiments, each dual battery interface 142, 144 may electrically and communicatively connect each battery 112A, 112B, 112C, 112D to the corresponding battery control circuit 102, 104. For instance, each dual battery interface may include a positive battery terminal, a negative battery terminal, and two communication terminals.

Power supply system 100 may be operable to interface four batteries simultaneously. Power supply system 100 may further include a tether interface 122 such that each battery control circuit 102, 104 may be operatively coupled to tether cable 120.

Each battery control circuit 102, 104 of the power supply system 100 may provide power via output power terminals (B+, B−). As shown in FIG. 3, the first battery control circuit 102 may include a first positive terminal 152 and a first negative terminal 154. Similarly, the second battery control circuit 104 may include a second positive terminal 162, and a second negative terminal 164. Specifically, each power terminal 152, 154, 162, 164 may be either a positive power terminal B+ (e.g., positive terminal B+) or a negative power terminal B− (e.g., negative terminal B−). As shown in FIG. 3, power terminal 152 and power terminal 162 may be positive terminals B+ while power terminal 154 and power terminal 164 may be negative terminals B−.

Tether cable 120 may include a first adapter assembly 126 operatively coupling first battery control circuit 102 to the dual battery power tool 310 (e.g., via first tool battery interface 312) and a second adapter assembly 128 operatively coupling second battery control circuit 104 to the dual battery power tool 310 (e.g., via second tool battery interface 314).

In some embodiments, tether cable 120 may include a power wire 332, 334, 342, 344 for each power terminal 152, 154, 162, 164. For instance, a first positive terminal 152 may be coupled to a first adapter assembly 126 via a first positive power wire 332. The first negative terminal 154 may be coupled to first adapter assembly 126 via a first negative power wire 334. The second positive terminal 162 may be coupled to a second adapter assembly 128 via a second positive power wire 342. A second negative terminal 164 may be coupled to second adapter assembly 128 via a second negative power wire 344.

In some embodiments, each battery control circuit 102, 104 may be communicatively coupled to the dual battery power tool 310 via communication lines 336, 346 of tether cable 120. For instance, each battery control circuit 102, 104 may include a controller that may communicate with one or more corresponding batteries 112A, 112B, 112C, 112D. The controller of the battery control circuit 102, 104 may additionally communicate with dual battery tool 310 by, for instance, communication lines 336, 346. As such, tether cable 120 may further include a first communication line 336 communicatively coupling the first battery control circuit 102 to the dual battery tool 310 and a second communication line 346 communicatively coupling the second battery control circuit 104 to the dual battery power tool 310.

The first adapter assembly 126 and second adapter assembly 128 may each be operable to connect the tether cable 120 to the one or more tool battery interfaces 312, 314. As shown in FIG. 3, power tool system 300 may include a dual battery power tool 310 having a first tool battery interface 312 and a second tool battery interface 314 such that dual battery power tool 310 may receive power from two batteries. In some embodiments, first tool battery interface 312 may be a high side tool battery interface and second tool battery interface 314 may be a low side tool battery interface.

Dual battery tool 310 may further include a voltage control system 316 configured to, for instance, control or regulate the voltage provided to one or more operational components, such as a motor of dual battery tool 310.

Voltage control system 316 may be operable to receive power via the first tool battery interface 312 and/or the second tool battery interface 314. As shown, voltage control system 316 may be operably coupled to each power terminal 152, 154 of the first battery control circuit 102 as well as each power terminal 162, 164 of the second battery control circuit 104. Specifically, voltage control system 316 may be coupled to shared node 190 along with the first negative terminal 154 and the second positive terminal 162.

The power terminals 152, 154 of the first battery control circuit 102 and the power terminals 162, 164 of the second battery control circuit 104 may be connected in a series configuration (e.g., configured in series) via shared node 190. For instance, first negative power terminal 154 may be coupled to second positive power terminal 162 via a shared node 190.

As shown in FIG. 3, shared node 190 may be positioned within the dual battery power tool 310 such that the first negative terminal 154 is connected in series with the second positive terminal 162 via the tether cable 120 and the dual battery power tool 310. For instance, the first negative terminal 154 may be connected to the shared node 190 through first negative power wire 334, first adapter assembly 126, and first tool battery interface 312 while the second positive terminal 162 may be connected to the shared node 190 through second positive power wire 342, second adapter assembly 128, and second tool battery interface 314.

In other embodiments, shared node 190 may be positioned within the tether cable 120 such that the first negative terminal 154 is connected in series with the second positive terminal 162 via only the tether cable 120. In further embodiments, the shared node 190 may be positioned within the power supply system 100, such as within the tether interface 122.

Power supply system 100 may further include a plurality of negative voltage suppression diodes D1, D2. As shown, each diode D1, D2 may be electrically coupled between an output terminal of the first plurality of output power terminals 152, 154 and a second output terminal of the second plurality of output power terminals 162, 164. For instance, each diode D1, D2 may electrically couple a power terminal 152, 154 of the first battery control circuit 102 to a power terminal 162, 164 of the second battery control circuit.

Specifically, first diode D1 may electrically couple a positive terminal B+of the first battery control circuit 102 (e.g., first positive terminal 152) to a negative terminal B-of the second battery control circuit 104 (e.g., second negative terminal 164). In addition, second diode D2 may electrically couple a negative terminal B− of the first battery control circuit 102 (e.g., first negative terminal 154) to a positive terminal B+ of the second battery control circuit 104 (e.g., second positive terminal 162). The second diode D2 may be configured in parallel with shared node 190 such that D2 may be placed in a short circuit configuration due to the first negative terminal 154 and the second positive terminal 162 both being connected to the shared node 190 as well as the diode D2.

Each diode D1, D2 may have an anode (e.g., positive side) coupled to a negative terminal 154, 164 and a cathode (e.g., negative side) coupled to a positive terminal 152, 162. For instance, as shown in FIG. 3, diode D1 includes an anode coupled to second negative terminal 164 and a cathode coupled to first positive terminal 152. Similarly, diode D2 includes an anode coupled to first negative terminal 154 and a cathode coupled to second positive terminal 162.

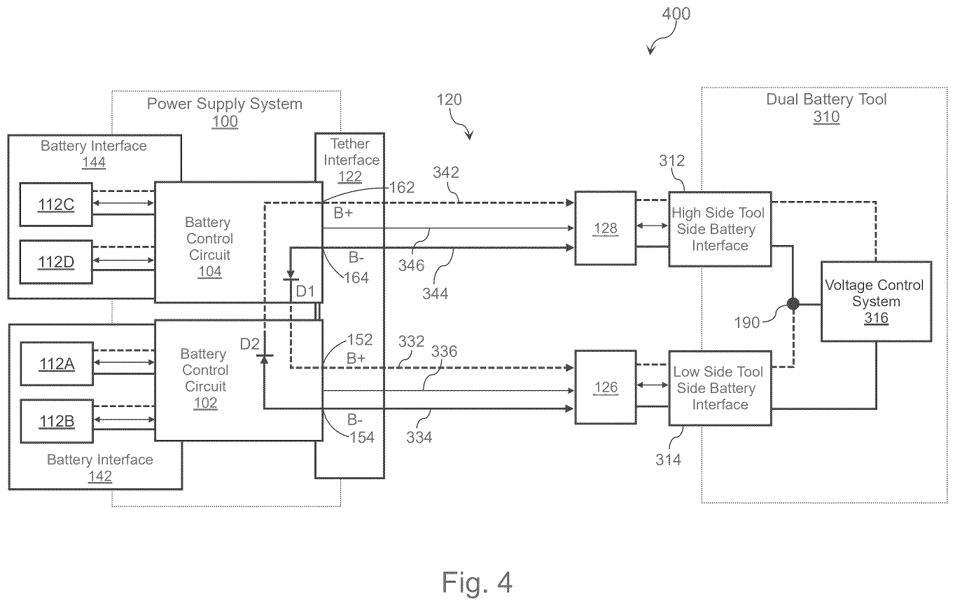

FIG. 4 provides a circuit schematic of an example power tool system 400 in accordance with embodiments of the present disclosure. Power tool system 400 may include power supply system 100, tether cable 120, and dual battery tool 310. Specifically, power tool system 400 of FIG. 4 depicts an alternative connection configuration between the power supply system 100 and the dual battery tool 310 as shown in FIG. 3.

As shown, power tool system 400 of FIG. 4 may include the second battery control circuit 104 of power supply system 100 being set as the high side battery control circuit and first battery control circuit 102 of power supply system 100 being set as the low side battery control circuit. For instance, first battery control circuit 102 may be operatively coupled to the dual battery tool 310 via the low side tool interface 314 while battery control circuit 104 may be coupled to the dual battery tool 310 via the high side tool interface 312.

In the configuration shown in FIG. 4, diode D2 may be positioned across both the first battery control circuit 102 and the second battery control circuit 104. Additionally, D1 may be shorted out due to the negative terminal 164 of the second battery control circuit 104 sharing a connection with the positive terminal 152 of the first battery control circuit 102.

Referring back to FIG. 3, the first battery control circuit 102 may be set as the high side battery control circuit while the second battery control circuit 104 may be set as the low side battery control circuit. In this configuration, D1 may be positioned across both the first battery control circuit 102 and the second battery control circuit 104. Additionally, D2 may be shorted out due to the negative terminal 154 of the first battery control circuit 102 sharing a connection with the positive terminal 162 of the second battery control circuit 104.

As shown in FIGS. 3 and 4, the first battery control circuit 102 and the second battery control circuit 104 may be interchangeably used as the high side battery control circuit or the low side battery control circuit. Accordingly, the first battery control circuit 102 and the second battery control circuit 104 may each be operable to be connected to either the first tool battery interface 312 or the second tool battery interface 314 of a dual battery tool 310. As shown, first positive power wire 332, first negative power wire 334, and first adapter assembly 126 may connect the first battery control circuit 102 to the high side tool battery interface 312 (FIG. 3) or the low side tool battery interface 314 (FIG. 4). Similarly, second positive power wire 342, second negative power wire 344, and second adaptor assembly 128 may connect the second battery control circuit 104 to the low side tool battery interface 314 (FIG. 3) or the high side tool battery interface 312 (FIG. 4).

Accordingly, diodes D1, D2 may provide for negative voltage suppression regardless of which battery control circuit 102, 104 is used as the high side battery control circuit or the low side battery control circuit. For instance, in both configurations shown in FIGS. 3 and 4, diode D1 may connect across second negative power wire 344 and first positive power wire 332 while D2 may connect across first negative power wire 334 and second positive power wire 342.

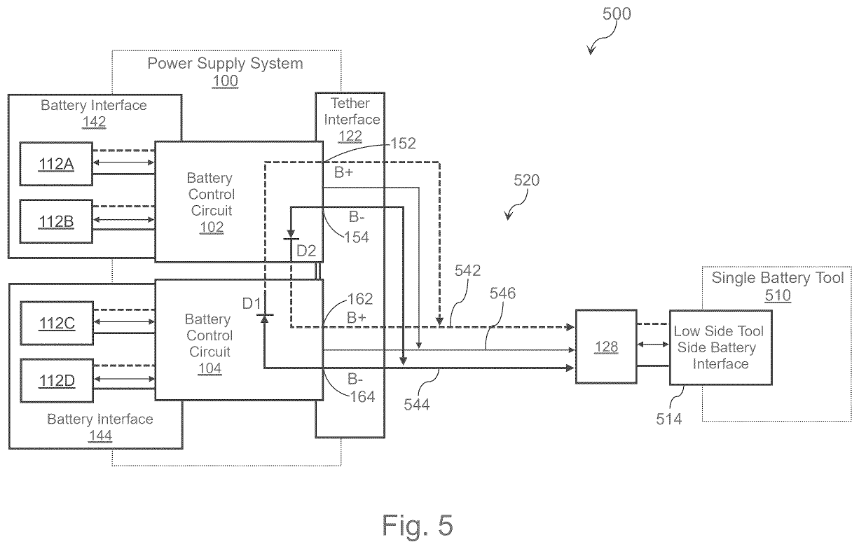

FIG. 5 provides a circuit schematic of an example power tool system 500 in accordance with embodiments of the present disclosure. Power tool system 500 may include a power supply system 100, a tether cable 520, and a single battery power tool 510. Specifically, power tool system 500 of FIG. 5 depicts a connection configuration between the power supply system 100 as shown in FIGS. 3 and 4 and a single battery power tool 510. Accordingly, power supply system 100 may be configured to provide power to a dual battery power tool 310 (FIGS. 3 and 4) or a single battery power tool 510 as depicted in FIG. 5.

As shown in FIG. 5, single battery power tool 510 may include a single tool battery interface 514. In some embodiments, the single tool battery interface 514 may be a low side tool battery interface such as tool battery interface 314 shown in FIGS. 3 and 4. A tether cable 520 may be configured to electrically couple the first battery control circuit 102 and the second battery control circuit 104 to the single tool battery interface 514. Specifically, the first battery control circuit 102 and the second battery control circuit 104 may be configured in parallel such that a singular positive power wire 542 and a singular negative power wire 544 is connected to the single battery power tool 510 (e.g., via adapter assembly 128). As such, diode D1 and diode D2 may also be configured in parallel.

In some embodiments, tether cable 520 may be further configured to communicatively couple the first battery control circuit 102 and the second battery control circuit 104 to the single tool battery interface 514 via a singular communication wire 546. Accordingly, power supply system 100 may be electrically and communicatively coupled to the single battery tool 510 via the tether cable 520.

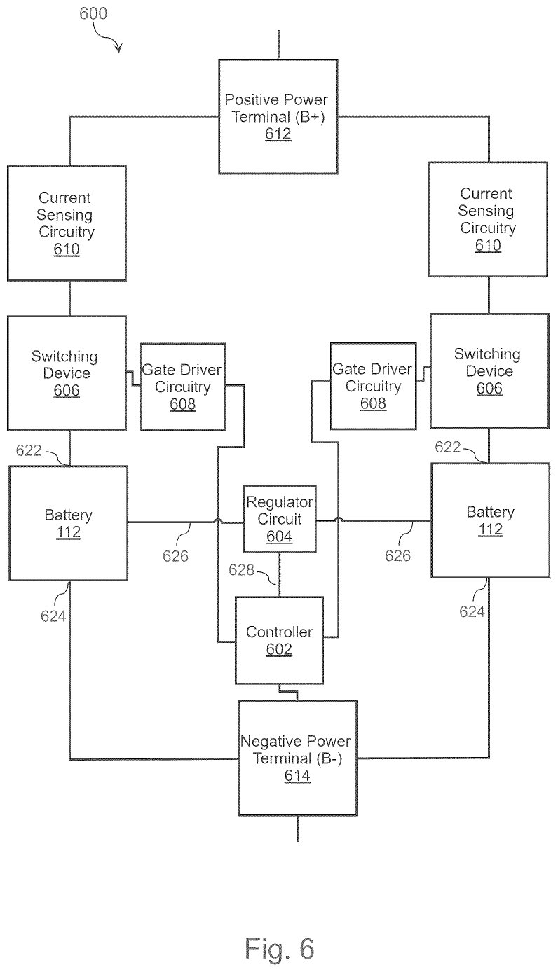

Referring now to FIG. 6, a circuit schematic of an example battery control circuit 600 and two example batteries 112 is provided in accordance with embodiments of the present disclosure. Specifically, battery control circuit 600 may be implemented in a power supply system, such as power supply system 100 depicted in FIGS. 3-5 . For instance, first battery control circuit 102 and/or a second battery control circuit 104 depicted in FIGS. 3-5 may be a battery control circuit 600 as depicted in FIG. 6.

Battery control circuit 600 may be operable to interface one or more (e.g., two) batteries 112. Battery control circuit 600 is configured to provide power from the one or more batteries 112 via the positive power output terminal (B+) 612 and the negative power output terminal (B−) 614.

As shown, a positive battery terminal 622 of each battery 112 may be connected to positive power output terminal (B+) 612 via a switching device 606, such as a solid state disconnect switch. Each switching device 606 may be controlled (e.g., switched between an open state and a closed state) by a controller 602 via the corresponding gate driver circuitry 608. In addition, a negative battery terminal 624 of each battery 112 may be connected to negative power output terminal (B−) 614.

In some embodiments, each battery 112 may be connected to positive power output terminal (B+) 612 via a switching device 606 and current sensing circuitry 610. For instance, each current sensing circuitry 610 may include a resistor for measuring current.

In some embodiments, controller 602 may be powered by batteries 112. For instance, each battery 112 may be connected to a regulator circuit 604 via a voltage rail 626. Regulator circuit 604 may provide power to controller 602 via a controller voltage rail 628, such as a 3.3 volt [V] voltage rail, based on voltage rail 626. Each battery 112 may also communicate with controller 602 via, for instance, a communications circuit.

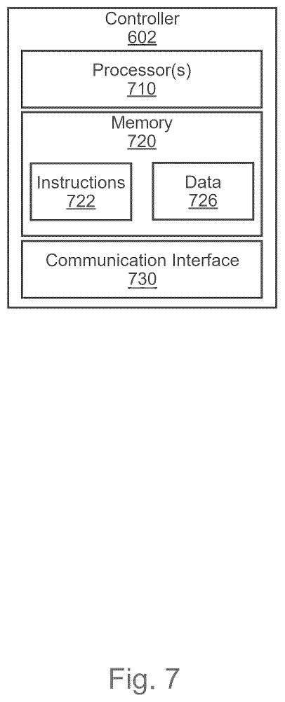

FIG. 7 provides a block diagram of a controller 602 in accordance with example embodiments of the present disclosure. As shown, a controller 602 may include one or more processor(s) 710. The one or more processor(s) 710 can include any suitable processing device, such as a microprocessor, microcontroller, integrated circuit, logic device, or other suitable processing device. Controller 602 may further include one or more memory device(s) 720. The one or more memory device(s) 720 can include one or more computer-readable media, including, but not limited to, non-transitory computer-readable media, RAM, ROM, hard drives, flash drives, or other memory devices.

The one or more memory device(s) 720 can store information accessible by the one or more processor(s) 710, including computer-readable instructions 722 that can be executed by the one or more processor(s) 710. The instructions 722 can be any set of instructions that when executed by the one or more processor(s) 710, cause the one or more processor(s) 710 to perform operations. The instructions 722 can be software written in any suitable programming language or can be implemented in hardware. In some embodiments, the instructions 722 can be executed by the one or more processor(s) 710 to cause the one or more processor(s) 710 to perform operations.

The memory device(s) 720 can further store data 726 that can be accessed by the one or more processor(s) 710. The data 726 can include one or more table(s), function(s), algorithm(s), model(s), equation(s), etc. according to example embodiments of the present disclosure.

Controller 602 can also include a communication interface 730 used to communicate, for example, with the other components of system. The communication interface 730 can include any suitable components for interfacing with one or more network(s), including for example, transmitters, receivers, ports, controllers, antennas, or other suitable components.

Further aspects of the disclosure are provided by one or more of the following embodiments:

In accordance with one embodiment, a power supply system for a power tool is provided. The power supply system includes a first battery control circuit operable to interface one or more first batteries, the first battery control circuit having a first positive terminal and a first negative terminal. The power supply system further includes a second battery control circuit operable to interface one or more second batteries, the second battery control circuit having a second positive terminal and a second negative terminal. The power supply system further includes a first diode electrically coupled between the first positive terminal and the second negative terminal. The power supply system further includes a second diode electrically coupled between the first negative terminal and the second positive terminal. The power supply system is operable to provide power to the power tool via a tether cable, the tether cable configured to couple the first battery control circuit and the second battery control circuit of the power supply system to one or more tool battery interfaces of the power tool.

The power supply system of any one or more of the embodiments, wherein the first battery control circuit and the second battery control circuit are configured in series such that the first negative terminal is electrically coupled to the second positive terminal via a shared node, the shared node configured in parallel with the second diode.

The power supply system of any one or more of the embodiments, wherein the shared node is positioned within the power tool.

The power supply system of any one or more of the embodiments, wherein the power tool comprises a voltage control system operably coupled to the first positive terminal, the second negative terminal, and the shared node.

The power supply system of any one or more of the embodiments, wherein the power tool is a dual battery power tool having a first tool battery interface and a second tool battery interface, the tether cable configured to: electrically and communicatively couple the first battery control circuit to the first tool battery interface of the dual battery power tool; and electrically and communicatively couple the second battery control circuit to the second tool battery interface of the dual battery power tool.

The power supply system of any one or more of the embodiments, wherein the power tool is a single battery power tool having a single tool battery interface, the tether cable configured to electrically and communicatively couple the first battery control circuit and the second battery control circuit to the single tool battery interface of the single battery power tool.

The power supply system of any one or more of the embodiments, wherein the first battery control circuit and the second battery control circuit are configured in a parallel.

The power supply system of any one or more of the embodiments, wherein the first battery control circuit and the second battery control circuit are each operable to be connected to any tool battery interface of the one or more tool battery interfaces.

The power supply system of any one or more of the embodiments, wherein the power supply system is a backpack power supply system.

In accordance with another embodiment, a power tool system is provided. The power tool system includes a power tool comprising one or more tool battery interfaces for receiving power. The power tool system further includes a tether cable comprising one or more adapter assemblies operable to connect the tether cable to the one or more tool battery interfaces of the power tool. The power tool system further includes a power supply system operable to provide power to the power tool via the tether cable. The power supply system includes a first battery control circuit operable to interface one or more first batteries, the first battery control circuit having a first positive terminal and a first negative terminal. The power supply system further includes a second battery control circuit operable to interface one or more second batteries, the second battery control circuit having a second positive terminal and a second negative terminal. The power supply system further includes a first diode electrically coupled between the first positive terminal and the second negative terminal. The power supply system further includes a second diode electrically coupled between the first negative terminal and the second positive terminal.

The power tool system of any one or more of the embodiments, wherein the first diode has an anode coupled to the second negative terminal.

The power tool system of any one or more of the embodiments, wherein the second diode has an anode coupled to the first negative terminal.

The power tool system of any one or more of the embodiments, wherein the first battery control circuit and the second battery control circuit are configured in series such that the first negative terminal is electrically coupled to the second positive terminal via a shared node, the shared node configured in parallel with the second diode.

The power tool system of any one or more of the embodiments, wherein the shared node is positioned within the power tool.

The power tool system of any one or more of the embodiments, wherein the first battery control circuit and the second battery control circuit are each communicatively coupled to the power tool via a communication line of the tether cable.

The power tool system of any one or more of the embodiments, wherein the first battery control circuit and the second battery control circuit are each operable to be connected to any tool battery interface of the one or more tool battery interfaces.

The power tool system of any one or more of the embodiments, wherein the power supply system comprises a backpack power supply system.

In accordance with another embodiment, a power tool system is provided. The power tool system includes a dual battery power tool comprising a first tool battery interface and a second tool battery interface for receiving power. The power tool system further includes a backpack power supply system operable to provide power to the dual battery power tool. The backpack power supply system includes a first battery control circuit operable to interface one or more first batteries, the first battery control circuit having a first positive terminal and a first negative terminal. The backpack power supply system further includes a second battery control circuit operable to interface one or more second batteries, the second battery control circuit having a second positive terminal and a second negative terminal. The backpack power supply system further includes a first diode electrically coupled between the first positive terminal and the second negative terminal. The backpack power supply system further includes a second diode electrically coupled between the first negative terminal and the second positive terminal.

The power tool system of any one or more of the embodiments, wherein the first battery control circuit and the second battery control circuit are configured in series such that the first negative terminal is electrically coupled to the second positive terminal via a shared node, the shared node configured in parallel with the second diode.

The power tool system of any one or more of the embodiments, wherein the first battery control circuit and the second battery control circuit are each operable to be connected to either the first tool battery interface or the second tool battery interface of the dual battery power tool.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A power supply system for a power tool, the power supply system comprising:
a first battery control circuit operable to interface one or more first batteries, the first battery control circuit having a first positive terminal and a first negative terminal;
a second battery control circuit operable to interface one or more second batteries, the second battery control circuit having a second positive terminal and a second negative terminal;
a first diode electrically coupled between the first positive terminal and the second negative terminal; and
a second diode electrically coupled between the first negative terminal and the second positive terminal,
wherein the power supply system is operable to provide power to the power tool via a tether cable, the tether cable configured to couple the first battery control circuit and the second battery control circuit of the power supply system to one or more tool battery interfaces of the power tool.

2. The power supply system of claim 1, wherein the first battery control circuit and the second battery control circuit are configured in series such that the first negative terminal is electrically coupled to the second positive terminal via a shared node, the shared node configured in parallel with the second diode.

3. The power supply system of claim 2, wherein the shared node is positioned within the power tool.

4. The power supply system of claim 2, wherein the power tool comprises a voltage control system operably coupled to the first positive terminal, the second negative terminal, and the shared node.

5. The power supply system of claim 1, wherein the power tool is a dual battery power tool having a first tool battery interface and a second tool battery interface, the tether cable configured to:
electrically and communicatively couple the first battery control circuit to the first tool battery interface of the dual battery power tool; and
electrically and communicatively couple the second battery control circuit to the second tool battery interface of the dual battery power tool.

6. The power supply system of claim 1, wherein the power tool is a single battery power tool having a single tool battery interface, the tether cable configured to:
electrically and communicatively couple the first battery control circuit and the second battery control circuit to the single tool battery interface of the single battery power tool.

7. The power supply system of claim 6, wherein the first battery control circuit and the second battery control circuit are configured in a parallel.

8. The power supply system of claim 1, wherein the first battery control circuit and the second battery control circuit are each operable to be connected to any tool battery interface of the one or more tool battery interfaces.

9. The power supply system of claim 1, wherein the power supply system is a backpack power supply system.

10. A power tool system, comprising:
a power tool comprising one or more tool battery interfaces for receiving power;
a tether cable comprising one or more adapter assemblies operable to connect the tether cable to the one or more tool battery interfaces of the power tool; and
a power supply system operable to provide power to the power tool via the tether cable, the power supply system comprising:
a first battery control circuit operable to interface one or more first batteries, the first battery control circuit having a first positive terminal and a first negative terminal;
a second battery control circuit operable to interface one or more second batteries, the second battery control circuit having a second positive terminal and a second negative terminal;
a first diode electrically coupled between the first positive terminal and the second negative terminal; and
a second diode electrically coupled between the first negative terminal and the second positive terminal.

11. The power tool system of claim 10, wherein the first diode has an anode coupled to the second negative terminal.

12. The power tool system of claim 11, wherein the second diode has an anode coupled to the first negative terminal.

13. The power tool system of claim 10, wherein the first battery control circuit and the second battery control circuit are configured in series such that the first negative terminal is electrically coupled to the second positive terminal via a shared node, the shared node configured in parallel with the second diode.

14. The power tool system of claim 13, wherein the shared node is positioned within the power tool.

15. The power tool system of claim 10, wherein the first battery control circuit and the second battery control circuit are each communicatively coupled to the power tool via a communication line of the tether cable.

16. The power tool system of claim 10, wherein the first battery control circuit and the second battery control circuit are each operable to be connected to any tool battery interface of the one or more tool battery interfaces.

17. The power tool system of claim 13, wherein the power supply system comprises a backpack power supply system.

18. A power tool system, comprising:
a dual battery power tool comprising a first tool battery interface and a second tool battery interface for receiving power; and
a backpack power supply system operable to provide power to the dual battery power tool, the backpack power supply system comprising:
a first battery control circuit operable to interface one or more first batteries, the first battery control circuit having a first positive terminal and a first negative terminal;
a second battery control circuit operable to interface one or more second batteries, the second battery control circuit having a second positive terminal and a second negative terminal;
a first diode electrically coupled between the first positive terminal and the second negative terminal; and
a second diode electrically coupled between the first negative terminal and the second positive terminal.

19. The power tool system of claim 18, wherein the first battery control circuit and the second battery control circuit are configured in series such that the first negative terminal is electrically coupled to the second positive terminal via a shared node, the shared node configured in parallel with the second diode.

20. The power tool system of claim 18, wherein the first battery control circuit and the second battery control circuit are each operable to be connected to either the first tool battery interface or the second tool battery interface of the dual battery power tool.
